(19) United States
(12) Patent Application Publication
(10) Pub. No.: US 2016/0338316 A1
(43) Pub. Date: Nov. 24, 2016

(54) SMALL PET HABITAT UNITS AND SYSTEMS AND METHODS INCLUDING SAME

(71) Applicant: Arni Says Saves LLC, Daytona Beach, FL (US)

(72) Inventors: Russell Richard Niedwick, Newport Coast, CA (US); Nicole Marisa Linn, Ormond Beach, FL (US); Paul Hendrikx, Breda (NL); Melchior van Voorden, Breda (NL); Hendrik Richard Ulderink, Breda (NL)

(21) Appl. No.: 15/154,363

(22) Filed: May 13, 2016

Related U.S. Application Data
(60) Provisional application No. 62/163,154, filed on May 18, 2015.

(51) Int. Cl. A01K 1/03; A01K 15/02; A01K 5/00; A01K 1/035

(52) U.S. Cl. CPC A01K 1/033; A01K 1/0353; A01K 15/024; A01K 5/00

(57) ABSTRACT

A small pet habitat system includes a plurality of modular habitat units. Each of the habitat units includes a rigid housing defining a chamber, at least one integral coupling feature, and a functional component. The habitat units are configured to be modularly stacked to form a multi-unit pet habitat structure in which the coupling features of adjacent ones of the habitat units interlock to limit relative movement between said adjacent habitat units. At least two of the habitat units have different functional components from one another.

### RELATED APPLICATION(S)

The present application claims the benefit of and priority from U.S. Provisional Patent Application No. 62/163,154, filed May 18, 2015, the disclosure of which is incorporated herein by reference in its entirety.

### FIELD OF THE INVENTION

The present invention relates to pet habitats and, more particularly, to modular small pet habitats.

### BACKGROUND OF THE INVENTION

Pet owners often wish to provide their pets, such as domesticated cats and small dogs, with dedicated shelters or habitats for rest or play. To this end, various pet shelters and toys have been offered in the past. However, known apparatus of this type (e.g., cat beds and houses, and dog beds and houses) are typically unattractive and/or lack durability and versatility.

### SUMMARY

According to embodiments of the invention, a small pet habitat system includes a plurality of modular habitat units. Each of the habitat units includes a rigid housing defining a chamber, at least one integral coupling feature, and a functional component. The habitat units are configured to be modularly stacked to form a multi-unit pet habitat structure in which the coupling features of adjacent ones of the habitat units interlock to limit relative movement between said adjacent habitat units. At least two of the habitat units have different functional components from one another.

In some embodiments, at least one of the habitat units is a bed unit including a bed cushion as the functional component thereof.

In some embodiments, at least one of the habitat units is a scratching post unit including a scratching post as the functional component thereof.

According to some embodiments, at least one of the habitat units is a play unit including a pet toy as the functional component thereof.

In some embodiments, at least one of the habitat units is a feeding unit including a feeding container as the functional component thereof.

According to some embodiments, the plurality of habitat units includes at least two functional components from the group consisting of a bed cushion, a scratching post, a pet toy, and a feeding container.

In some embodiments, the plurality of habitat units includes a first habitat unit and a second habitat unit each including a top panel and a bottom panel, the at least one coupling feature of the first habitat unit includes a recess defined in the top panel of the first habitat unit, the at least one coupling feature of the second habitat unit includes a foot projecting from the bottom panel of the second habitat unit, and the first and second habitat units are configured to be modularly stacked to form the multi-unit pet habitat structure wherein the second habitat unit is stacked on top of the first habitat unit and the foot is seated in the recess to limit relative movement between the first and second habitat units.

According to some embodiments, the habitat units are collapsible.

In some embodiments, each of the housings includes a plurality of discrete panels and an integral panel attachment system configured to secure the panels together to form the housing. The panel attachment system includes attachment features integrally molded with the panels to secure the panels to one another.

The housings may be formed of a polymeric material.

According to some embodiments, at least one of the habitat units includes a shelf wall member disposed in the chamber thereof.

According to some embodiments, the housing includes a front panel and a rear panel on opposed sides of the chamber. A portal is defined in the front panel. An ornamental indicia is located on the rear panel and visible through the portal and the chamber. The portal has a first ornamental shape. The ornamental indicia has a second ornamental shape complementing the first ornamental shape. When the ornamental indicia is viewed through the portal, the first and second ornamental shapes collectively form a combined ornamentation. In some embodiments, the first ornamental shape represents an outline of a head of an animal, and the second ornamental shape represents one or more facial features of the head of the animal.

The small pet habitat system may include a locking mechanism configured to releasably affix the at least two of the habitat units to one another.

According to method embodiments of the invention, a method for forming a small pet habitat structure includes providing a plurality of modular habitat units. Each of the habitat units includes a rigid housing defining a chamber, at least one integral coupling feature, and a functional component. The method further includes modularly stacking the habitat units to form a multi-unit pet habitat structure in which the coupling features of adjacent ones of the habitat units interlock to limit relative movement between said adjacent habitat units. At least two of the habitat units have different functional components from one another.

According to embodiments of the invention, a small pet habitat structure includes a plurality of modular habitat units. Each of the habitat units includes a rigid housing defining a chamber, at least one integral coupling feature, and a functional component. The habitat units are modularly stacked to such that the coupling features of adjacent ones of the habitat units are interlocked to limit relative movement between said adjacent habitat units. At least two of the habitat units have different functional components from one another.

According to embodiments of the invention, a small pet habitat unit includes a rigid housing defining a chamber and having a front panel and a rear panel on opposed sides of the chamber. A portal is defined in the front panel. An ornamental indicia is located on the rear panel and visible through the portal and the chamber. The portal has a first ornamental shape. The ornamental indicia has a second ornamental shape complementing the first ornamental shape. When the ornamental indicia is viewed through the portal, the first and second ornamental shapes collectively form a combined ornamentation.

In some embodiments, the first ornamental shape represents an outline of a head of an animal, and the second ornamental shape represents one or more facial features of the head of the animal.

Further features, advantages and details of the present invention will be appreciated by those of ordinary skill in the art from a reading of the figures and the detailed description of the embodiments that follow, such description being merely illustrative of the present invention.

### BRIEF DESCRIPTION OF THE DRAWINGS

FIG. 1 is a front perspective view of a small pet habitat system according to embodiments of the invention.

FIG. 2 is a front view of the small pet habitat system of FIG. 1.

FIG. 3 is an enlarged, fragmentary, cross-sectional view of the small pet habitat system of FIG. 1 taken along the line 3-3 of FIG. 1.

FIG. 4 is a front perspective view of a bed unit forming a part of the small pet habitat system of FIG. 1.

FIG. 5 is a rear perspective view of the bed unit of FIG. 4.

FIG. 6 is an exploded, front perspective view of the bed unit of FIG. 4.

FIG. 7 is an enlarged, fragmentary, perspective view of the bed unit of FIG. 4.

FIG. 8 is a side view of the bed unit of FIG. 4.

FIG. 9 is a top view of the bed unit of FIG. 4.

FIG. 10 is a bottom view of the bed unit of FIG. 4.

FIG. 11 is a front perspective view of a scratching post unit forming a part of the small pet habitat system of FIG. 1.

FIG. 12 is an exploded, front perspective view of the scratching post unit of FIG. 11.

FIG. 13 is a front perspective view of a play unit forming a part of the small pet habitat system of FIG. 1.

FIG. 14 is an exploded, front perspective view of the play unit of FIG. 13.

FIG. 15 is a front perspective view of a feeding unit forming a part of the small pet habitat system of FIG. 1.

FIG. 16 is an exploded, front perspective view of the feeding unit of FIG. 15.

FIG. 17 is a front perspective view of a bed unit according to further embodiments of the invention.

FIG. 18 is a rear perspective view of the bed unit of FIG. 17.

FIG. 19 is a front view of the bed unit of FIG. 17.

FIG. 20 is a rear view of the bed unit of FIG. 17.

FIG. 21 is a front perspective view of a bed unit according to further embodiments of the invention.

FIG. 22 is a rear perspective view of the bed unit of FIG. 21.

FIG. 23 is a front perspective view of a scratching post unit according to further embodiments of the invention.

FIG. 24 is a front perspective view of a play unit according to further embodiments of the invention.

FIG. 25 is a front perspective view of a small pet habitat system according to further embodiments of the invention.

FIG. 26 is an exploded, fragmentary, perspective view of a pet habitat according to further embodiments of the invention and including a locking mechanism.

FIG. 27 is a side view of a locking device forming a part of the locking mechanism of FIG. 26.

FIG. 28 is a top view of the pet habitat of FIG. 26.

FIG. 29 is a cross-sectional view of the pet habitat of FIG. 28 taken along the line 29-29 of FIG. 28.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

As used herein, “monolithic” means an object that is a single, unitary piece formed or composed of a material without joints or seams.

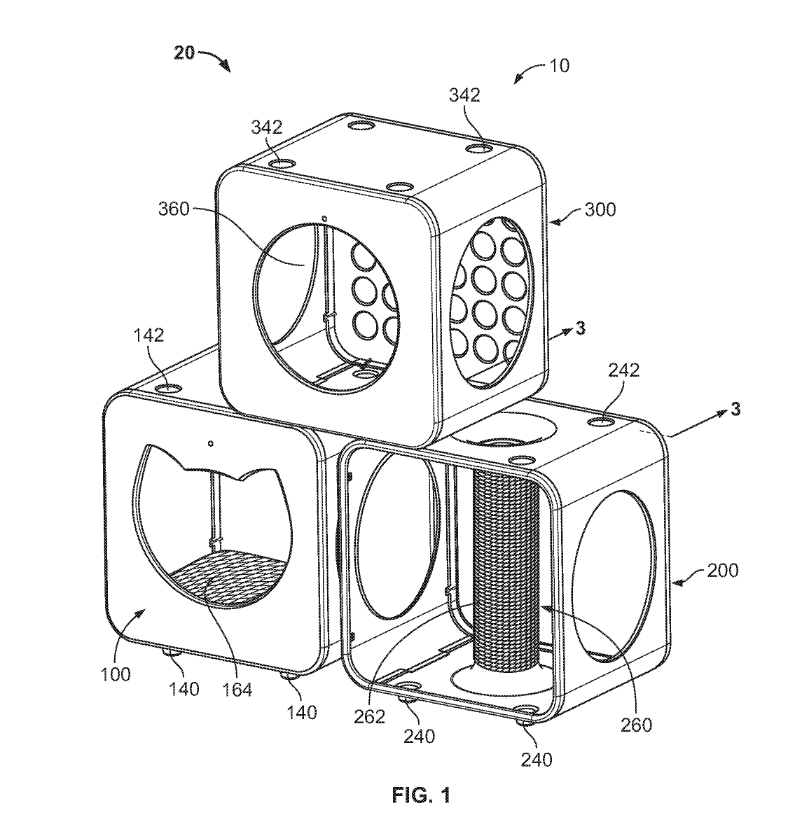

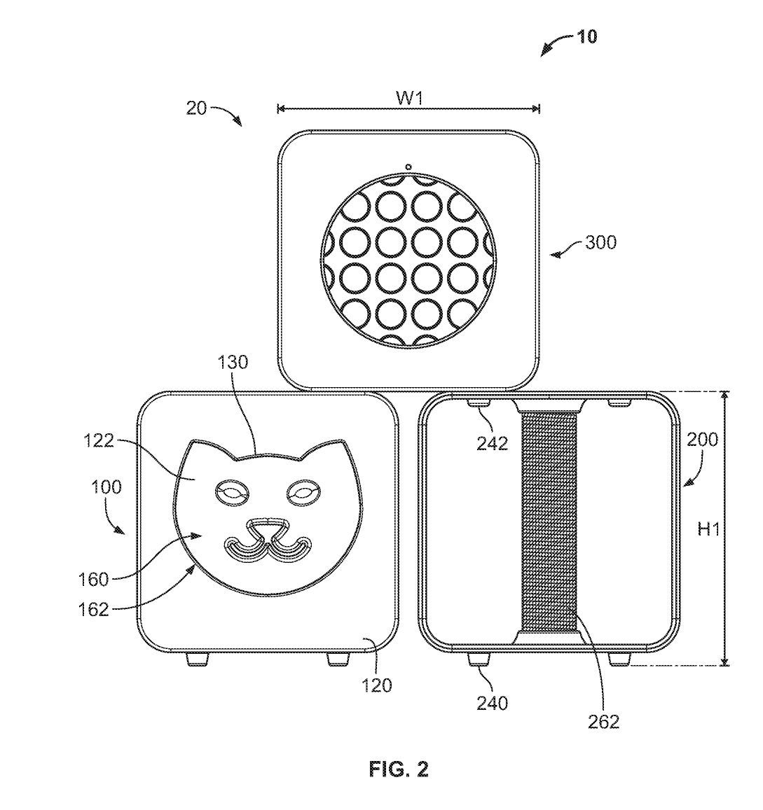

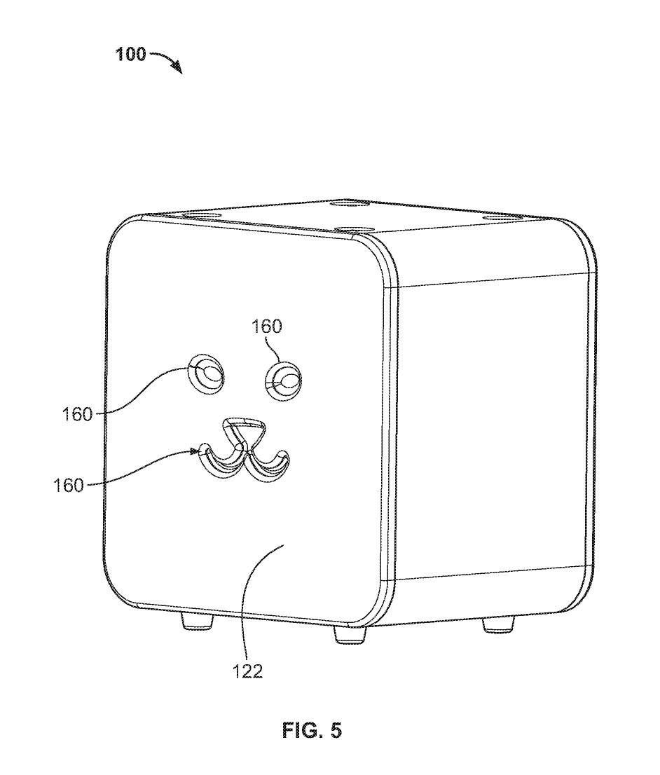

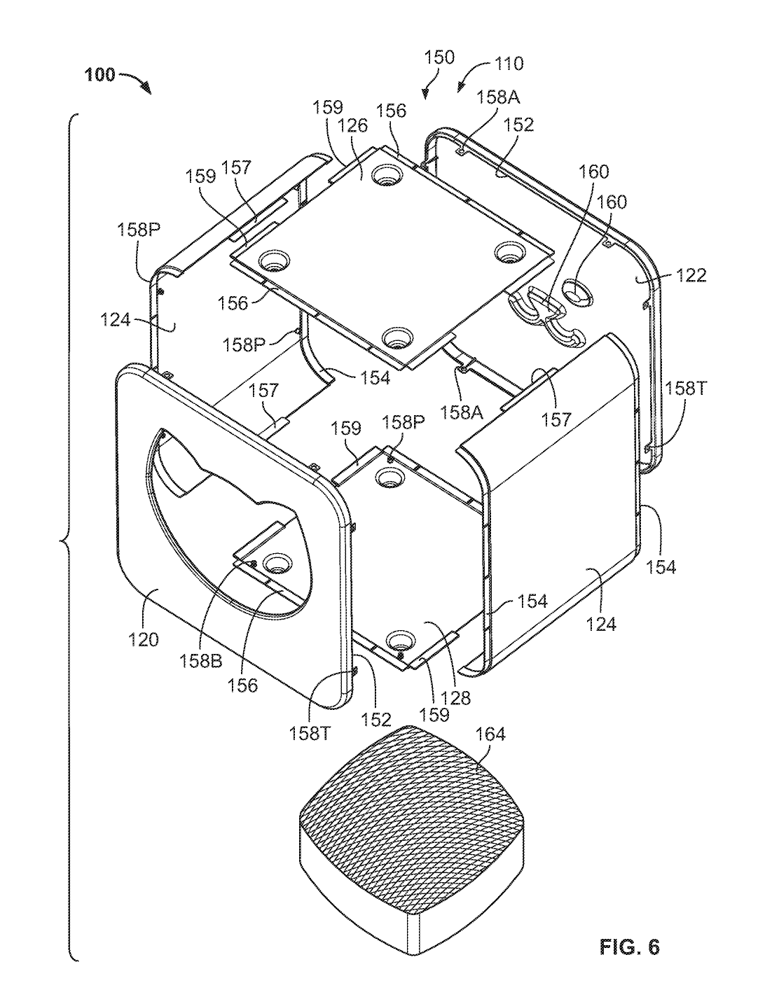

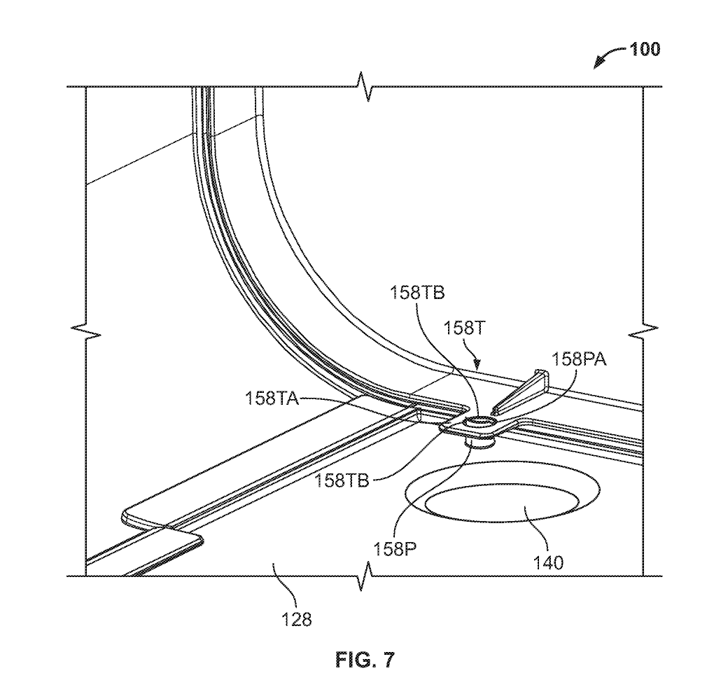

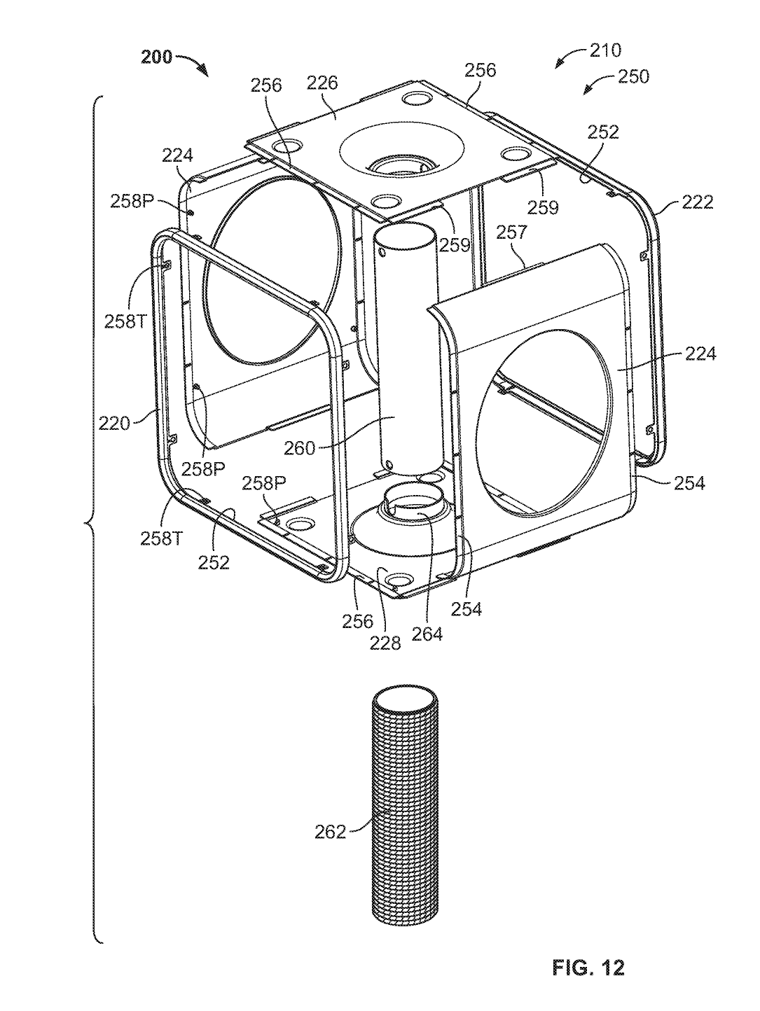

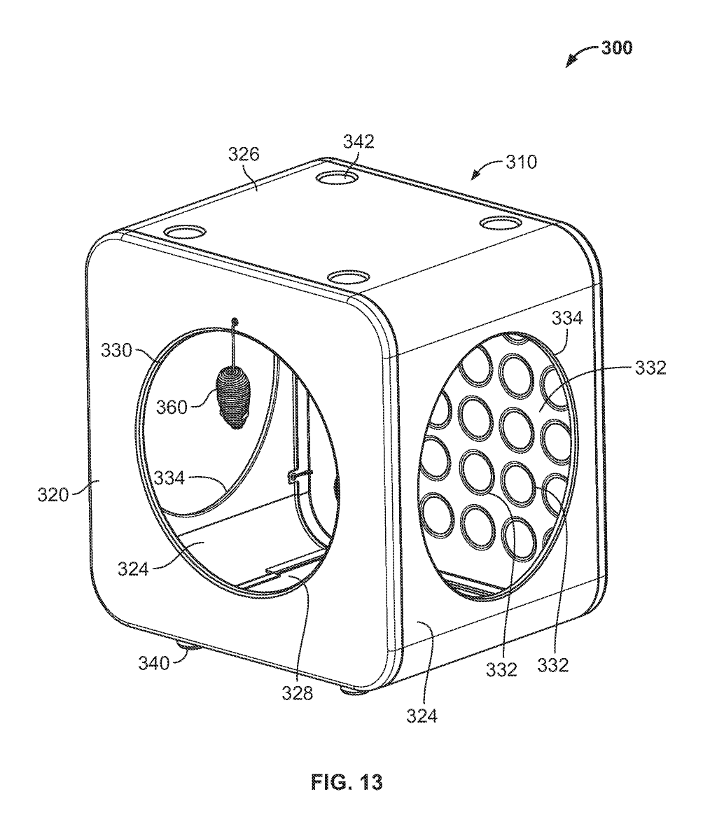

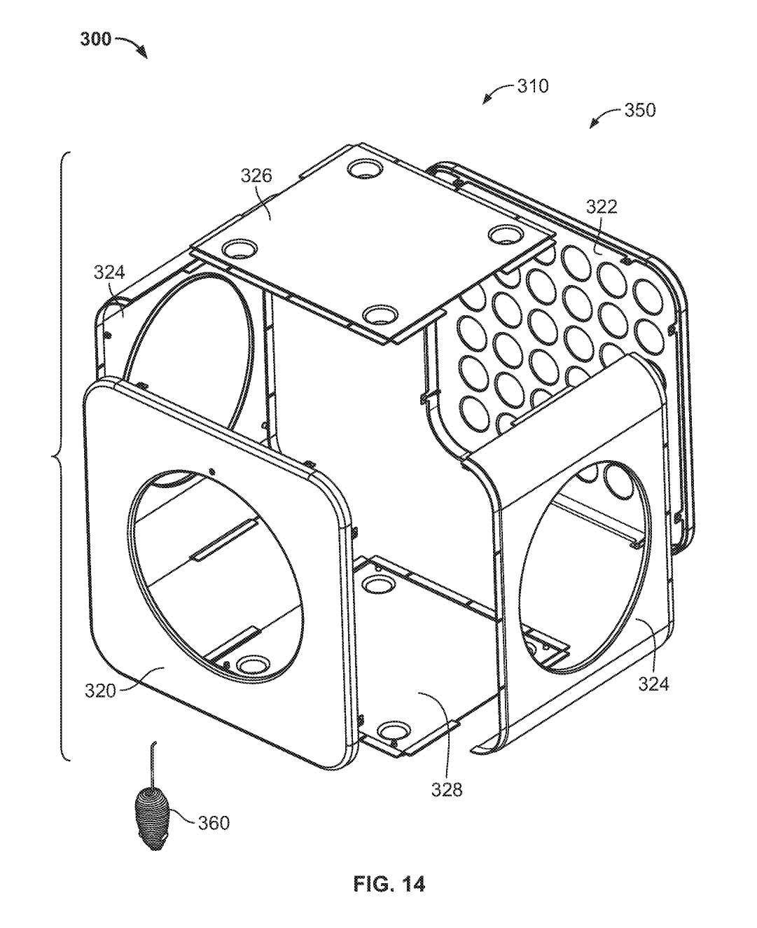

With reference to FIGS. 1-16, a small pet shelter or habitat system 10 according to embodiments of the present invention is shown therein. The system 10 includes a bed module or unit 100, a scratching post module or unit 200, a play module or unit 300, and a feeding module or unit 400 according to embodiments of the invention. As discussed herein, the discrete units 100-400 can be modularly and cooperatively combined, configured and stacked to form one or more pet habitat structures (e.g., the habitat structure 20 as shown in FIGS. 1 and 2). However, in some embodiments, the units 100-400 can be used independently of one another. For example, the units 100-400 can each be used as individual, standalone small pet habitats as well. As discussed in more detail below, each unit 100-400 includes a housing and a functional component (e.g., a cushion, a scratching post, a toy, or a feeding bowl).

The small pet habitat system 10 and units 100-400 according to embodiments of the invention may be particularly well-suited and applied for use in the care of or by small domestic animals or pets. In particular, the small pet habitat system 10 and units 100-400 may be used as living (e.g., sleeping, playing, eating) habitat for domesticated, indoor cats and dogs.

With reference to FIGS. 1-10, the bed unit 100 includes a housing 110 defining a chamber 102 and a bedding component or cushion 164 (not shown in FIG. 4) disposed in the chamber 102.

The housing 110 includes a front panel 120, a rear panel 122, opposed side panels 124, a top panel 126 and a bottom panel 128. The housing 110 is a cuboid or has the shape generally of a rectangular prism. According to some embodiments and as illustrated, the housing 110 has rounded or arcuately profiled corners 112 extending from the front panel 120 to the rear panel 122, and the remaining corners are substantially sharp or square.

An opening or portal 130 for ingress into and egress from the chamber 102 is defined in the front panel 120. According to some embodiments and as illustrated, the portal 130 has a first ornamental shape. In particular, the portal 130 has the shape of the silhouette of or representing a cat's head and the unit 100 and system 10 may be intended and configured for use by a domestic cat. It will be appreciated that the portal 130 may have other ornamental designs, such as designs of other styles or representing animals of other types.

The bed unit 100 further includes ornamental indicia 160 located on the rear panel 122 and visible through the portal 130. The ornamental indicia 160 has a second ornamental shape or appearance different from that of the ornamental shape of the portal 130. As shown, the indicia 160 is embossed, molded or otherwise formed in the rear panel 122. However, in some embodiments, the indicia 160 may be a layer printed, painted or the like on the interior of the rear panel 122. As best seen in FIG. 2, from the front of the unit 100 the indicia 160 is visible through the portal 130 such that the indicia 160 is framed thereby. As a result, the profile or outline of the portal 130 and the indicia 160 collectively form a combined ornamental feature 162 or ornamentation of the unit 100. The ornamental shape of the indicia 160 complements the ornamental shape of the portal 130. In some embodiments and as illustrated, the portal 130 forms the outline of an animal's head (e.g., a cat's head as shown) and the indicia 160 forms facial features of the animal's head (e.g., eyes, nose and mouth as shown).

The bed unit 100 is further provided with integral feet 140 projecting downwardly from the bottom panel 128 and integral recesses 142 extending down into the top panel 126.

The discrete, individual panels 120-128 are coupled or secured to one another by an integral panel attachment system 150 to form the housing 110. The panel attachment system 150 includes integral annular slots 152 defined in the front and rear panels 120, 122, integral edge flanges 154 on the side panels 124, integral edge flanges 156 projecting from the front and rear edges of the top and bottom panels 126, 128, integral finger tabs 157 projecting from the lateral edges of the side panels 124, integral finger tabs 159 projecting from the lateral edges of the top and bottom panels 126, 128, integral interlock or lock features 158T (cantilevered tabs with holes) on the front and rear panels 120, 122, and cooperating integral interlock or lock features 158P (posts) on the side panels 124, top panel 126 and bottom panel 128. Each lock tab 158T and post 158P pair forms a clip or locking mechanism 158. In some embodiments and as shown, the lock tab features 158T each include a deflectable, cantilevered tab 158TA with hole 158TB defined therein, and the lock tab features 158P each include a post sized to fit closely within the associated hole 158TB. Each post 158P includes an outwardly facing ramped portion or surface 158PA on its free end. However, in accordance with other embodiments, other types and configurations of interlocking mechanisms may be used such as a socket and barbed tab.

In order to assemble the housing 110, the side panels 124 are attached to the panels 126, 128 by inserting the finger tabs 157 under the adjacent edges of the top and bottom panels 126, 128, and inserting the finger tabs 159 under the adjacent edges of the side panels 124. The front panel 120 is mounted on this subassembly such that the flanges 154, 156 are received in the slot 152 of the front panel 120 and the posts 158P interlock with the lock tabs 158T of the front panel 120. The rear panel 122 is mounted on the subassembly such that the flanges 154, 156 are received in the slot 152 of the rear panel 122 and the posts 158P interlock with the lock tabs 158T of the rear panel 122. In some embodiments, each lock tab 158T is automatically, elastically and resiliently deflected by the ramped portion 158PA and the lock tab 158T slides over the corresponding post 158P until the hole 158TB aligns with the post 158P, whereupon the lock tab 158T snaps over the post 158P to interlock therewith. In some embodiments, the user must lift the lock tabs 158T to clear the posts 158P during installation. The panels are thus clipped to one another by the cooperating features 158T, 158P.

The assembled housing 110 thus connected forms a substantially rigid, stable structure capable of bearing a load. According to some embodiments, the housing 110 is capable of sustaining a load on the top panel 126 of at least about 10 Kg (e.g., the weight of a large domestic cat) without deflecting more than about 10 percent and without plastically deforming. In some embodiments, the housing 110 can be disassembled by reversing the assembly steps to detach the panels 120-128 from one another. In some embodiments, the user must manually disengage each lock tab 158T from its post 158P to unlock the front and rear panels from the remaining panels.

With reference to FIGS. 1, 2, 11 and 12, the scratching post unit 200 includes a housing 210 defining a chamber 202 and a scratching post 260 disposed in the chamber 202.

The housing 210 includes a front frame or ring 220, a rear frame or ring 222, opposed side panels 224, a top panel 226 and a bottom panel 228. The housing 210 is generally square tubular. According to some embodiments and as illustrated, the housing 210 has rounded or arcuately profiled corners 212 extending from the front ring 220 to the rear ring 222, and the remaining corners are substantially sharp or square.

Openings or portals 230 and 234 for ingress into and egress from the chamber 102 are defined in the rings 220, 222 and the side panels 224.

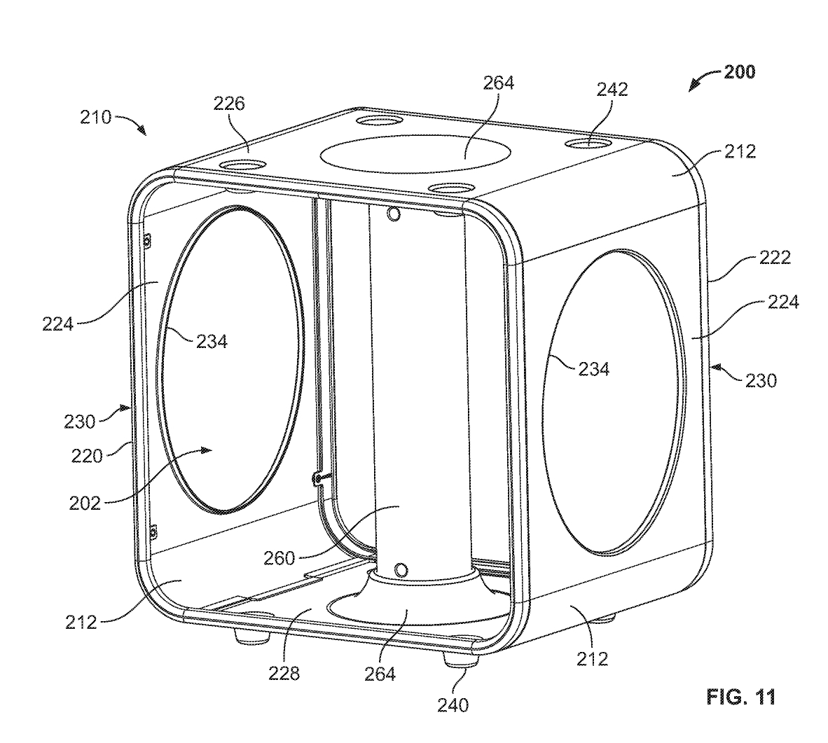

Each of the top panel 226 and the bottom panel 228 includes an integral, inwardly projecting post base feature 264. The scratching post 260 is held in place by the post bases 264. The scratching post 260 may include an outer layer of a suitable scratching media 262 (not shown in FIG. 11) such as a wound length of rope.

The scratching post unit 200 is further provided with integral feet 240 projecting downwardly from the bottom panel 228 and integral recesses extending down into the top panel 226.

The discrete, individual rings and panels 220-228 are coupled or secured to one another by an integral panel attachment system 250 to form the housing 210. The panel attachment system 250 includes integral annular slots 252 defined in the front and rear rings 220, 222, integral edge flanges 254 on the side panels 224, integral edge flanges 256 projecting from the front and rear edges of the top and bottom panels 226, 228, integral finger tabs 257 projecting from the lateral edges of the side panels 224, integral finger tabs 259 projecting from the lateral edges of the top and bottom panels 226, 228, integral interlock or lock tab features 258T (cantilevered tabs with holes) on the front and rear rings 220, 222, and cooperating integral interlock or snap tab features 258P (posts) on the side panels 224, top ring 226 and bottom ring 228.

The scratching post unit 200 may be assembled as follows. The scratching post 260 is mounted on the post bases 264 and thereby captured between the top and bottom panels 226, 228. The side panels 224 are then attached to the panels 226, 228 by inserting the finger tabs 257 under the adjacent edges of the top and bottom panels 226, 228, and inserting the finger tabs 259 under the adjacent edges of the side panels 224. The front ring 220 is mounted on this subassembly such that the flanges 254, 256 are received in the slot 252 of the front ring 220 and the posts 258P interlock with the lock tabs 258T of the front ring 220. The rear ring 222 is mounted on the subassembly such that the flanges 254, 256 are received in the slot 252 of the rear ring 222 and the posts 258P interlock with the lock tabs 258T of the rear panel 222.

The assembled housing 210 thus connected likewise forms a substantially rigid, stable structure capable of bearing a load as described above with regard to the unit 100. In some embodiments, the housing 210 can be disassembled by reversing the assembly steps to detach the rings and panels 220-228 from one another.

With reference to FIGS. 1, 2, 13 and 14, the play unit 300 includes a housing 310 defining a chamber 302. The housing 310 includes a front panel 320, a rear panel 322, opposed side panels 324, a top panel 326 and a bottom panel 328. The play unit 300 has integral feet 340 projecting downwardly from the bottom panel 328 and integral recesses 342 extending down into the top panel 326. The housing 310 includes an integral attachment system 350 corresponding to the attachment system 150 and is constructed and assembled in the same manner as the housing 110 except as follows.

In place of the ornamental portal 130, the front panel 320 is provided with a larger, round opening or portal 330. The rear panel 322 is provided with a plurality or array of smaller vent openings 332. The side panels 324 are also provided with portals 334.

The play unit 300 further includes a toy 360 (e.g., a toy mouse) that dangles or is suspended from a hole over the front portal 330. A pet within or outside of the chamber 302 may play with (e.g., bat) the toy 360.

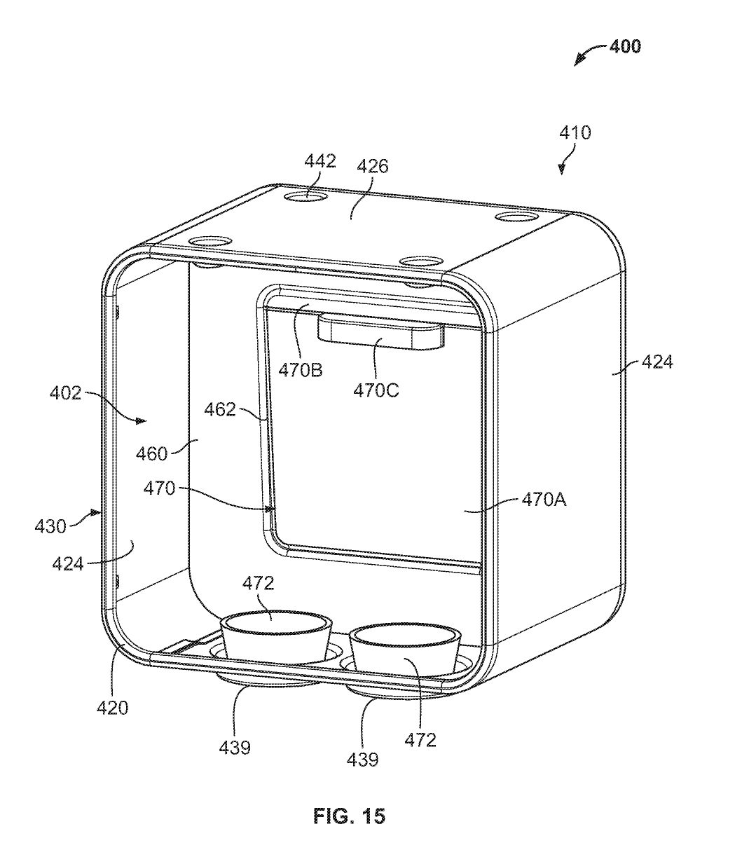

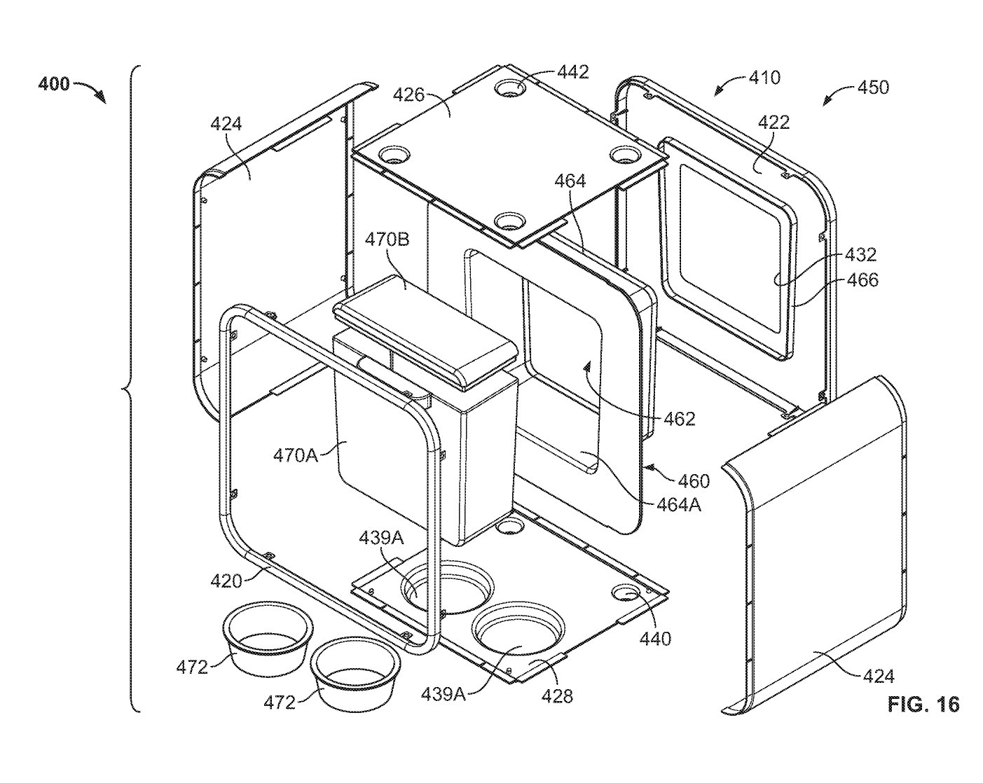

With reference to FIGS. 15 and 16, the feeding unit 400 includes a housing 410 defining a chamber 402. A shelf wall 460 is disposed in the chamber 402. Feeding bowls 472 and a food container 470 may also be disposed in the chamber 402, as discussed below.

The housing 410 includes a front frame or ring 420, a rear panel 422, opposed side panels 424, a top panel 426 and a bottom panel 428. The housing 410 is generally cuboid. According to some embodiments and as illustrated, the housing 410 has rounded or arcuately profiled edges extending from the front ring 420 to the rear panel 422, and the remaining edges are substantially sharp or square. The feeding unit 400 includes integral feet 440 projecting downwardly from the bottom panel 428 and integral recesses 442 extending down into the top panel 426.

The housing 410 includes an integral attachment system 450 corresponding to the attachment system 150 and is constructed and assembled in the same manner as the housing 110 except as follows. In place of the ornamental front panel 120, the housing 410 includes a large, substantially ground-level front portal 430 to facilitate pet access for eating from the chamber 402.

The rear panel 422 includes a rear portal 432 and an annular seat flange 466 projecting forwardly. The shelf wall 460 includes a rearwardly projecting annular wall 464 that is seated in the flange 466. The annular wall 464 defines a shelf slot 462 and a ledge 464A.

The food container 470 includes a bin 470A, a lid 470B and a handle 470C. The container 470 is sized to fit in the shelf slot 462. In some embodiments, the container 470 is shaped substantially congruently with the shelf slot 462 and is sized to substantially fill the shelf slot 462. In some embodiments, the bin 470A is translucent or transparent so that it may serve as a window for light through the portal 432. In use, the food container 470 can be stored in the shelf slot 462. The food container 470 can be removed from the slot 462 in order to dispense food to the bowls 472.

The bottom panel 438 includes food holder features 439 that define locator cavities 439A sized and positioned to hold and retain food and water bowls 472, for example. The food holder features 439 also serve as feet projecting downwardly from the bottom wall 428.

The panels and rings 120-128, 220-228, 320-328, 420-428 may be formed of any suitable material. According to some embodiments, the panels and rings 120-128, 220-228, 320-328, 420-428 are formed of a rigid or semi-rigid polymeric material. According to some embodiments, the panels and rings 120-128, 220-228, 320-328, 420-428 are formed of a rigid or semi-rigid polymeric material selected from the group consisting of polypropylene.

The panels and rings 120-128, 220-228, 320-328, 420-428 may be formed of the same or different materials from one another.

The panels and rings 120-128, 220-228, 320-328, 420-428 may be formed by any suitable technique. According to some embodiments, the panels and rings 120-128, 220-228, 320-328, 420-428 are each integrally formed and, according to some embodiments, are each unitarily molded. According to some embodiments, the panels and rings 120-128, 220-228, 320-328, 420-428 are each unitarily injection molded. In some embodiments, the panels and rings 120-128, 220-228, 320-328, 420-428 are each vacuum formed. According to some embodiments, the panels and rings 120-128, 220-228, 320-328, 420-428 are each monolithic.

According to some embodiments, the panels and rings 120-128, 220-228, 320-328, 420-428 are formed of a material having an E-modulus in the range of from about 1200 MPa to 1600 MPa. According to some embodiments, the panels and rings 120-128, 220-228, 320-328, 420-428 are formed of a material having a tensile strength in the range of from about 40 MPa to 70 MPa.

According to some embodiments, the panels and rings 120-128, 220-228, 320-328, 420-428 are formed of a material having a hardness of at least about 90 Rockwell “R” Scale and, in some embodiments, in the range of from about 90 Rockwell “R” Scale to 100 Rockwell “R” Scale.

The post 260 and/or the shelf wall 460 may also be formed of a material (e.g., a rigid polymeric material) and in a manner (e.g., injection molding) as described above for the panels and rings 120-128, 220-228, 320-328, 420-428.

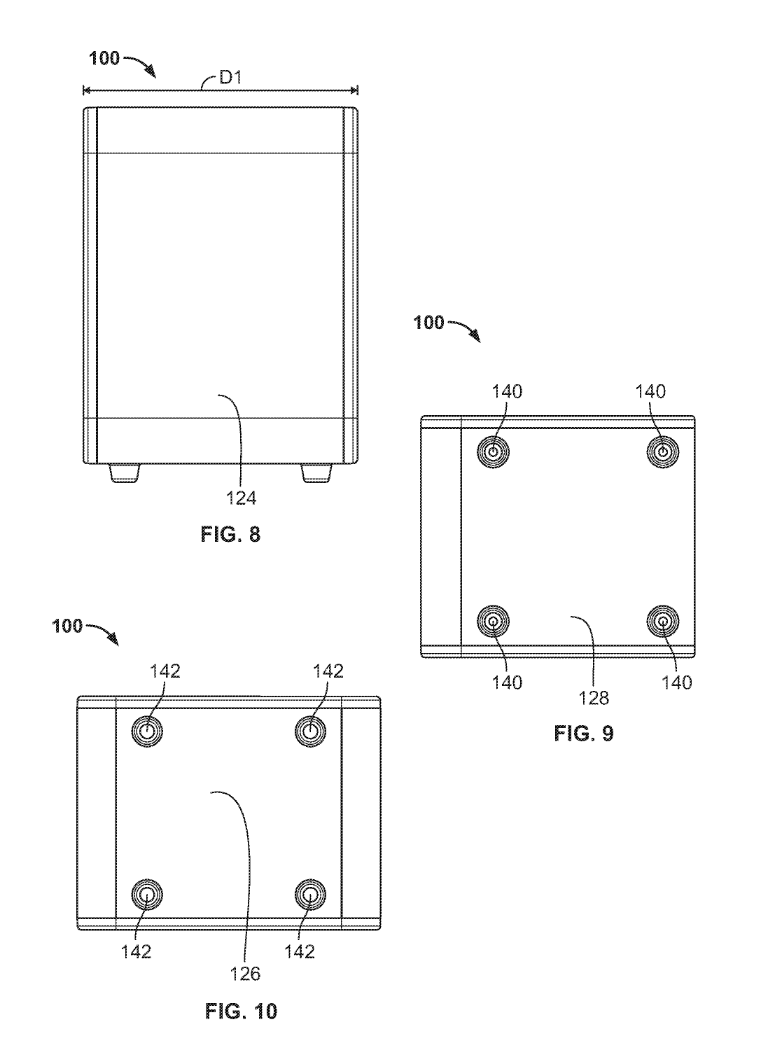

According to some embodiments, the housings 110, 210, 310, 410 each have a width W1 (FIG. 2) in the range of from about 380 to 400 mm, a height H1 (FIG. 2) in the range of from about 380 to 400 mm, and a depth D1 (FIG. 8) in the range of from about 290 to 310 mm.

According to some embodiments, the chambers 102, 202, 302, 402 each have a volume in the range of from about 40 to 45 cubic decimeters (dm³)

According to some embodiments, the panels 120-128, 224-228, 320-328, 422-428 each have a thickness T1 (FIG. 4) in the range of from about 1.8 to 2.2 mm.

The units 100-400 can be modularly assembled in a wide variety of configurations to form structures that suit the functional or aesthetic desires of the user. More than one of a given type of unit 100-400 can be included in a given installation. Thus, it can be seen that the system 10 can provide a high degree of versatility in layout to match the needs of the user.

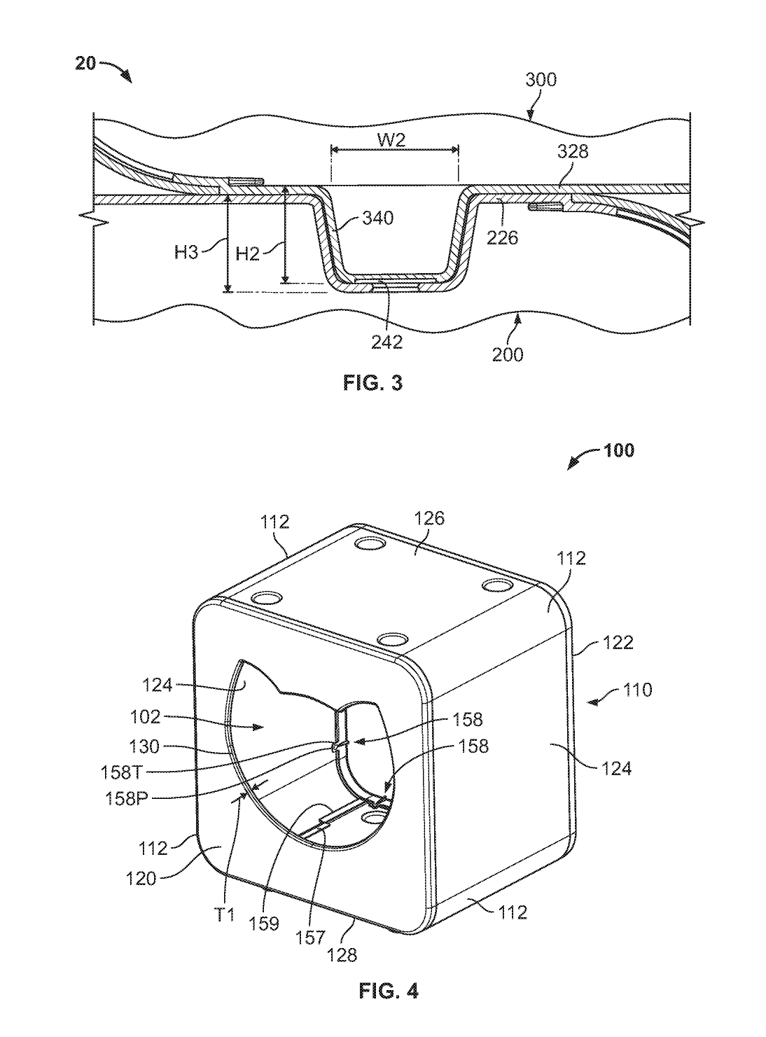

The feet 140, 240, 340, 440 and the recesses 142, 242, 342, 442 serve as cooperating, integral coupling features or mechanisms to interlock the units 100-400 when modularly stacked on one another. In particular, the feet and recesses can prevent or limit relative lateral movement between the stacked units 100-400. The shapes of the recesses 142, 242, 342, 442 are generally complementary to the shapes of the feet 140, 240, 340, 440 so that the feet can be easily inserted into corresponding recesses of another, adjacently underlying unit or units. In some embodiments, the height 112 (FIG. 3) of the feet 140, 240, 340, 440 is less than the depth 113 (FIG. 3) of the recesses 142, 242, 342, 442 so that, when the units are stacked, the feet do not bottom out in the recesses and the body of the bottom panel of the upper unit 100-400 rests on the body of the underlying unit 100-400.

When placed on the ground or other flat support surface, the feet 140, 240, 340, 440 will raise the bottom panel 128, 238, 338, 438 of the associated unit off the ground or surface.

Alternatively, each unit 100-400 can be mounted on top of one or a pair of other units 100-400 as shown in FIGS. 1 and 2, for example. In this case, the feet of the overlying unit 100 are received in the top recesses of the underlying unit 100-400. For example, in the structure 20 of FIGS. 1 and 2, the left pair of feet 340 of the play unit 300 are seated in the right pair of recesses 142 of the bed unit 100, and the right pair of feet 340 of the play unit 300 are seated in the left pair of recesses 242 of the scratching post unit 200. FIG. 3 shows an enlarged, fragmentary, cross-sectional view (taken along the line 3-3 of FIG. 1) of the interlocked engagement between the rear foot 340 of the unit 300 and the recess 242 of the unit 200.

With reference to FIG. 3, according to some embodiments, the height 112 of the feet 140, 240, 340, 440 is in the range of from about 19 to 21 mm. According to some embodiments, the depth 113 of the recesses 142, 242, 342, 442 is in the range of from about 19 to 21 mm. According to some embodiments, the width W2 of the feet is in the range of from about 0.5 to 1.5 mm greater than the corresponding width of the recesses 142, 242, 342, 442.

The integral attachment systems 150, 250, 350, 450 of the units 100-400 permit the housings 110, 210, 310, 410 to be provided unassembled or disassembled while nonetheless providing the housings 110, 210, 310, 410 with a desirable appearance and adequate strength, rigidity and load bearing capacity when assembled. Notably, the attachment features of the systems 150-450 may be substantially hidden from view from the exterior of the housing. In some embodiments, the housings 110-410 are shipped in a nonassembled state in order to minimize shipping volume. The housings 110-410 can then be conveniently assembled by a retailer or the consumer. The end user may also disassemble the housing for storage or transport, and thereafter reassemble the housing.

According to some embodiments, one or more of the units 100-400 are color customizable. In some embodiments, a customer is enabled to select the colors he or she desires for different panels or rings of a unit to be built. The customer can thereby configure a multi-color unit 100-400 in a combination of his or her choosing. In some embodiments, the colors or types of a cushion, scratching post, toy, or shelf wall can also be selectable by the customer.

In some embodiments, the customer is enabled to select from different types of panels or rings for a unit being configured. For example, the customer may configure a bed unit 100 having a vented rear wall 322 in place of the solid rear wall 122.

The foregoing customization may be enabled by and executed using an online configurator application provided on a Website portal.

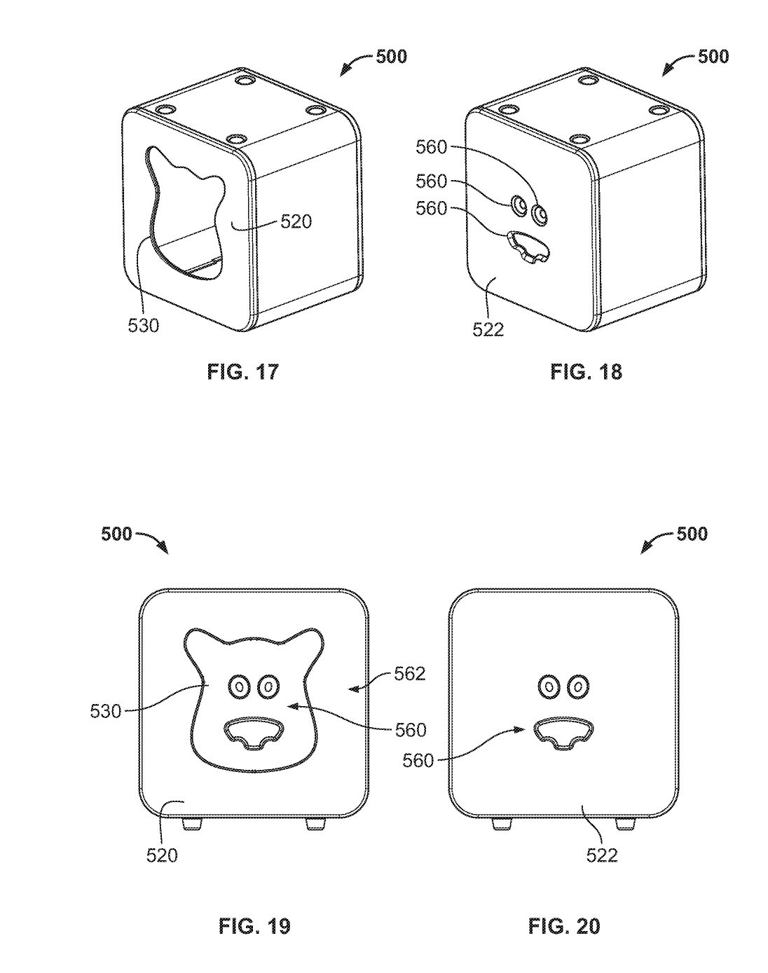

With reference to FIGS. 17-20, a bed unit 500 according to further embodiments of the invention is shown therein. The unit 500 may be intended and configured for use by a domesticated dog. The bed unit 500 corresponds to the bed unit 100 except that the bed unit 500 includes a portal 530 (in the front panel 520) in place of the portal 130 and indicia 560 in place of the indicia 160. The portal 530 has the shape of the silhouette of a dog's head. The ornamental indicia 560 located on the rear panel 522 is visible through the portal 530. The ornamental indicia 560 may likewise be embossed, molded or otherwise formed in the rear panel 522 or may be a layer printed, painted or the like on the interior of the rear panel 522. As best seen in FIG. 19, from the front of the unit 500 the indicia 560 is visible through the portal 530 such that the indicia 560 is framed thereby. As a result, the profile of the portal 530 and the indicia 560 collectively form a combined ornamental feature 562 or ornamentation of the unit 500. As illustrated, the portal 530 forms the outline of a dog's head and the indicia 560 forms facial features of the dog's head (e.g., eyes and nose).

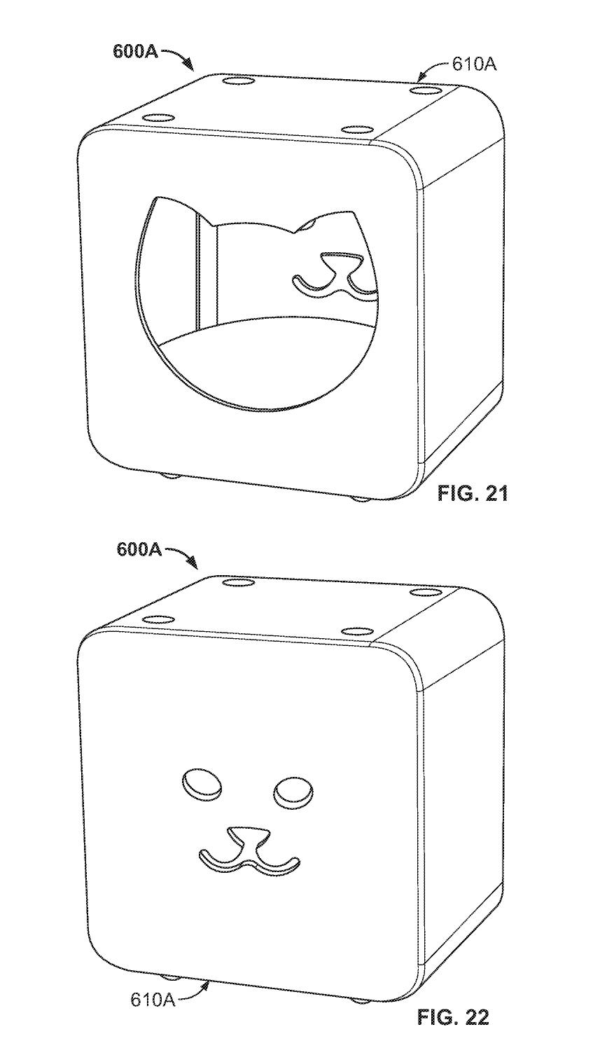

With reference to FIGS. 21 and 22, a bed unit 600A according to further embodiments of the invention is shown therein. The bed unit 600A corresponds to the bed unit 100 except that the housing 610A of the bed unit 600A is a unitarily molded, one piece component. According to some embodiments, the housing 610A is monolithic. In some embodiments, the housing 610A is rotary molded. The bed unit 600A may include a cushion 664 corresponding to the cushion 164.

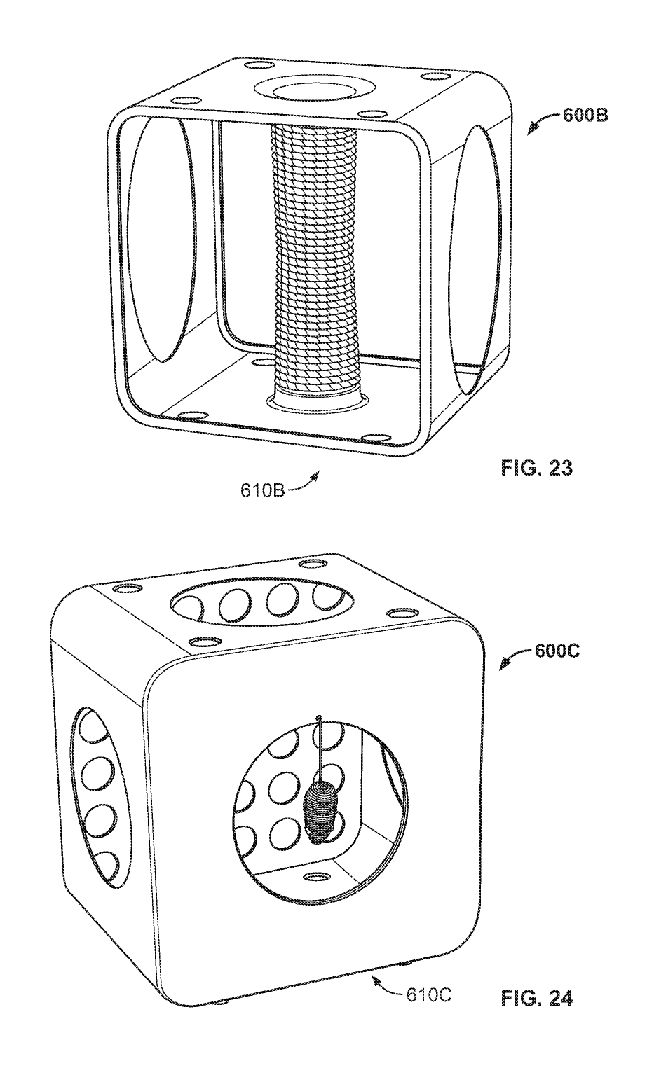

FIG. 23 shows a scratching post unit 600B that corresponds to the scratching post unit 200 except that the housing 610B of the scratching post unit 600B is a unitarily molded, one piece component, in some embodiments monolithic, and in some embodiments rotary molded.

FIG. 24 shows a play unit 600C that corresponds to the play unit 300 except that the housing 610C of the scratching post unit 600C is a unitarily molded, one piece component, in some embodiments monolithic, and in some embodiments rotary molded. Likewise, according to further embodiments, a feeding unit otherwise corresponding to the feeding unit 400 may likewise be formed having a housing so constructed.

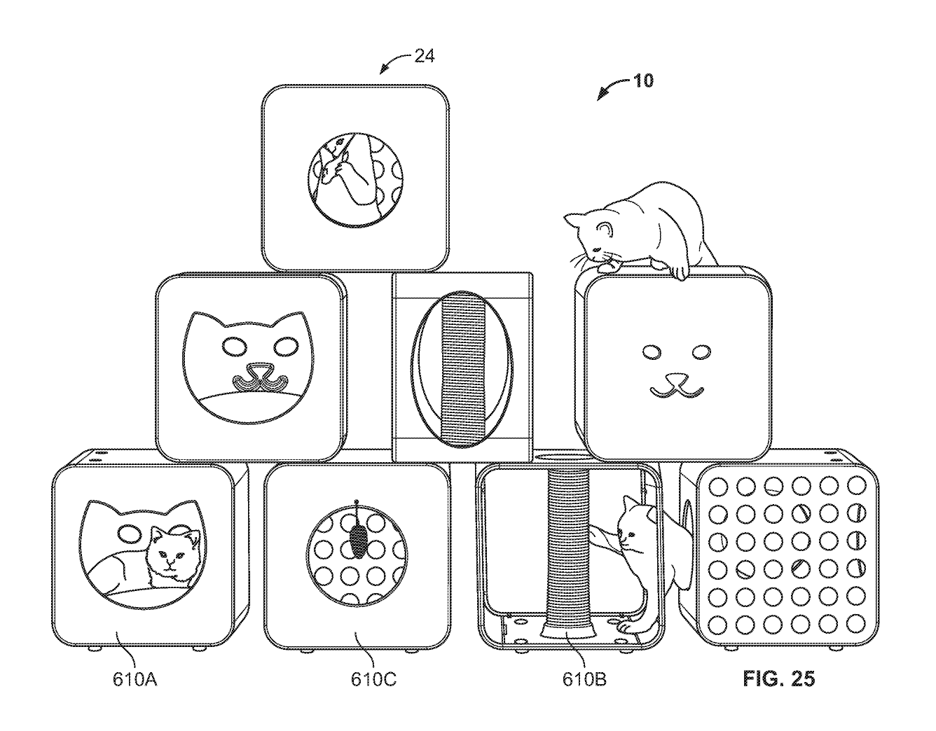

FIG. 25 shows an exemplary small pet habitat structure 24 constructed using the units 600A, 600B, 600C.

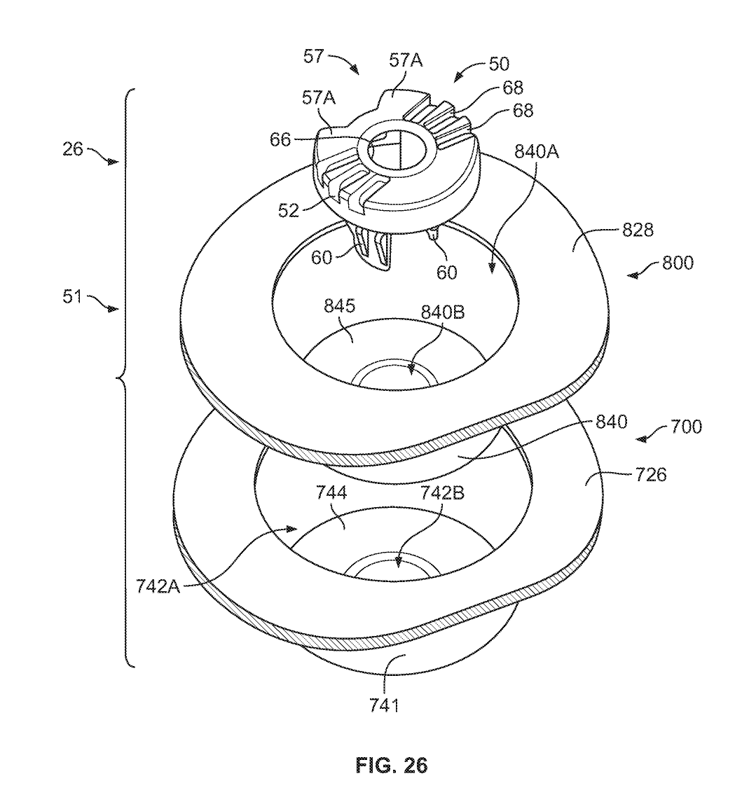

With reference to FIGS. 26-29, a pet habitat 26 according to embodiments of the invention is shown therein. The habitat 26 includes a lower module or unit 700 and an upper module or unit 800, which are shown only in fragmentary in the figures. The units 700, 800 may each correspond to and be constructed in the same manner as any of the units 100-600, for example, except as discussed below. The upper unit 800 is stacked on top of the lower unit 700 in the same manner as discussed above with respect to the units 300 and 200 with reference to FIG. 3.

The lower unit 700 includes a top panel 726 corresponding to the top panel 226. An integral socket or recess feature 741 is formed on the top panel 726 and defines a cavity or recess 742A corresponding to the recess 242. A central hole 742B is defined in an end or bottom wall 744 of the recess feature 741. The bottom wall 744 takes the form of a radially inwardly extending, annular flange.

The upper unit 800 includes a bottom panel 828 corresponding to the bottom panel 328. An integral foot 840 is formed on the bottom panel 828 and defines a cavity or recess 840A. A central hole 840B is defined in an end or bottom wall 845 of the foot 840. The bottom wall 845 takes the form of a radially inwardly extending, annular flange.

The locking mechanism 51 includes the bottom walls 844, 845 and a locking member, clip or device 50. The locking device 50 includes a cap 52 and a pair of opposed, radially spaced apart latch features 60.

The cap 52 includes a radially extending body 53 and an integral cylindrical wall or flange 54 depending from the body 53. A central hole 66 is defined in the body 53. A plurality of side slots 68 extend through the body 53 about the hole 66.

Each latch feature 60 includes a cantilevered leg 62 extending from a proximal end 62A (affixed in the body 53) to a free distal end 62B. An integral interlock feature 64 projects radially outwardly from each leg 62. In some embodiments and as shown, each interlock feature 64 is a tapered barb having a ramp face 64A and a land face 64B.

The locking device 50 may be formed of any suitable resilient material. In some embodiments, the locking device 50 is formed of a polymeric material. Suitable materials may include polypropylene. According to some embodiments, the locking device 50 is formed of a material having an E-modulus in the range of from about 1500 MPa to 2000 MPa. In some embodiments, the locking device 50 is formed of a material having a tensile strength in the range of from about 28 MPa to 36 MPa. According to some embodiment, the locking device 50 is unitary. According to some embodiments, the locking device 50 is monolithic. According to some embodiments, the locking device 50 is unitary molded such as by injection molding.

The locking mechanism 51 may be used as follows to selectively secured the upper unit 800 to the lower unit 700. The unit 800 is placed on the unit 700 such that the foot 840 is seated in the recess 742A. The holes 742B and 840B will substantially align along an assembly axis A-A. The locking device 50 is then inserted (with leg distal ends 62B first or leading) in an insertion direction C along the axis A-A from above and through the holes 742B, 840B. The diameter of the hole 742B is less than the outer diameter of the interlock features 64 when the legs 62 are in their relaxed states. The user pushes the legs 62 through the holes 742B, 840B, causing the legs 62 to deflect radially inwardly, until the interlock features 64 clear the flange 744, whereupon the legs 62 resiliently spring or snap radially outwardly.

The flanges 744, 845 are thereby axially captured between the cap flange 54 and the interlock features 64. As a result, the top panel 726 is thereby coupled and secured to the bottom panel 828.

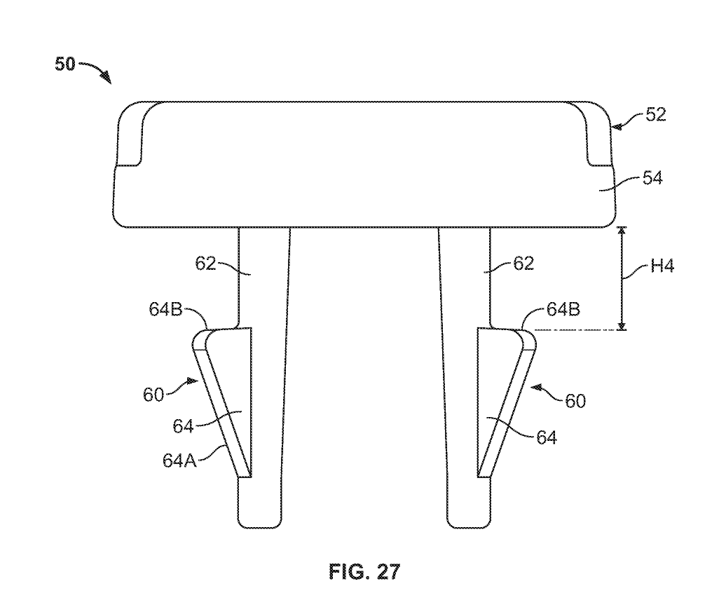

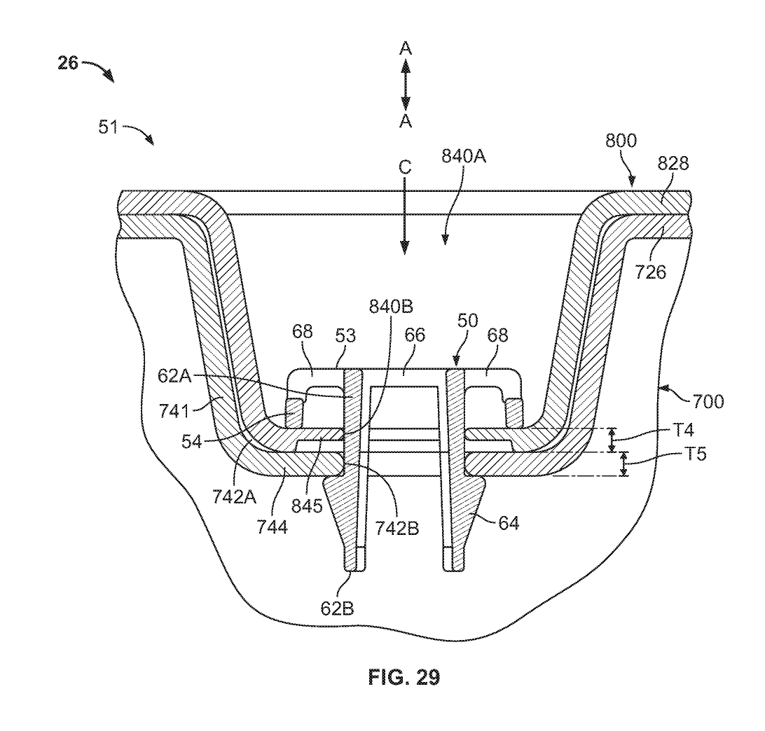

According to some embodiments, the distance 114 (FIG. 27) between the lands 64B and the lower edge of the cap flange 54 is in the range of from about 0 to 5 mm greater than the sum of the thickness T4 of the flange 844 and the thickness T5 of the flange 845 (FIG. 29).

The opening 66 and the slots 68 provide pathways for air through the features 741, 840 as well as in the event an animal or child puts the locking device 50 in its mouth.

The locking device 50 can be removed by pinching the legs 62 together to disengage the interlock features 64 and pushing the locking device 50 back up through the holes 742B, 840B.

The units 700, 800 may be secured to one another and or other units by additional locking mechanisms 51. For example, each nested foot 840 and recess feature 741 pair may be secured via a respective locking device 50.

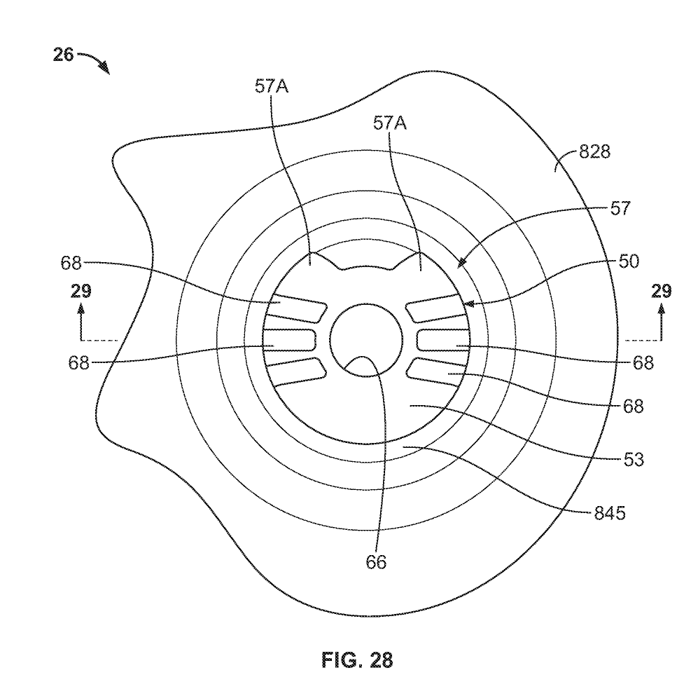

In some embodiments and as illustrated in FIGS. 26 and 28, the cap portion 52 is configured to have an ornamental profile, shape or indicia 57. In the illustrated embodiment, the ornamental shape 57 includes ear features 57A and the radial slots 68, which represent whiskers.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A small pet habitat system comprising:
a plurality of modular habitat units, each of the habitat units including:
a rigid housing defining a chamber;
at least one integral coupling feature; and
a functional component;
wherein the habitat units are configured to be modularly stacked to form a multi-unit pet habitat structure in which the coupling features of adjacent ones of the habitat units interlock to limit relative movement between said adjacent habitat units; and
wherein at least two of the habitat units have different functional components from one another.

2. The small pet habitat system of claim 1 wherein at least one of the habitat units is a bed unit including a bed cushion as the functional component thereof.

3. The small pet habitat system of claim 1 wherein at least one of the habitat units is a scratching post unit including a scratching post as the functional component thereof.

4. The small pet habitat system of claim 1 wherein at least one of the habitat units is a play unit including a pet toy as the functional component thereof.

5. The small pet habitat system of claim 1 wherein at least one of the habitat units is a feeding unit including a feeding container as the functional component thereof.

6. The small pet habitat system of claim 1 wherein the plurality of habitat units includes at least two functional components from the group consisting of a bed cushion, a scratching post, a pet toy, and a feeding container.

7. The small pet habitat system of claim 1 wherein:
the plurality of habitat units includes a first habitat unit and a second habitat unit each including a top panel and a bottom panel;
the at least one coupling feature of the first habitat unit includes a recess defined in the top panel of the first habitat unit;
the at least one coupling feature of the second habitat unit includes a foot projecting from the bottom panel of the second habitat unit; and
the first and second habitat units are configured to be modularly stacked to form the multi-unit pet habitat structure wherein the second habitat unit is stacked on top of the first habitat unit and the foot is seated in the recess to limit relative movement between the first and second habitat units.

8. The small pet habitat system of claim 1 wherein the habitat units are collapsible.

9. The small pet habitat system of claim 1 wherein each of the housings includes:
a plurality of discrete panels; and
an integral panel attachment system configured to secure the panels together to form the housing;
wherein the panel attachment system includes attachment features integrally molded with the panels to secure the panels to one another.

10. The small pet habitat system of claim 1 wherein the housings are formed of a polymeric material.

11. The small pet habitat system of claim 1 wherein at least one of the habitat units includes a shelf wall member disposed in the chamber thereof.

12. The small pet habitat system of claim 1 wherein:
the housing includes a front panel and a rear panel on opposed sides of the chamber;
a portal is defined in the front panel;
an ornamental indicia is located on the rear panel and visible through the portal and the chamber;
the portal has a first ornamental shape;
the ornamental indicia has a second ornamental shape complementing the first ornamental shape; and
when the ornamental indicia is viewed through the portal, the first and second ornamental shapes collectively form a combined ornamentation.

13. The small pet habitat system of claim 12 wherein:
the first ornamental shape represents an outline of a head of an animal; and
the second ornamental shape represents one or more facial features of the head of the animal.

14. The small pet habitat system of claim 1 including a locking mechanism configured to releasably affix the at least two of the habitat units to one another.

15. A method for forming a small pet habitat structure, the method comprising:
providing a plurality of modular habitat units, each of the habitat units including:
a rigid housing defining a chamber;
at least one integral coupling feature; and
a functional component; and
modularly stacking the habitat units to form a multi-unit pet habitat structure in which the coupling features of adjacent ones of the habitat units interlock to limit relative movement between said adjacent habitat units;
wherein at least two of the habitat units have different functional components from one another.

16. A small pet habitat structure comprising:
a plurality of modular habitat units, each of the habitat units including:
a rigid housing defining a chamber;
at least one integral coupling feature; and
a functional component;
wherein the habitat units are modularly stacked to such that the coupling features of adjacent ones of the habitat units are interlocked to limit relative movement between said adjacent habitat units; and
wherein at least two of the habitat units have different functional components from one another.

17. A small pet habitat unit comprising:
a rigid housing defining a chamber and having a front panel and a rear panel on opposed sides of the chamber;
a portal defined in the front panel; and
an ornamental indicia located on the rear panel and visible through the portal and the chamber;
wherein:
the portal has a first ornamental shape;
the ornamental indicia has a second ornamental shape complementing the first ornamental shape; and
when the ornamental indicia is viewed through the portal, the first and second ornamental shapes collectively form a combined ornamentation.

18. The small pet habitat unit of claim 17 wherein:
the first ornamental shape represents an outline of a head of an animal; and
the second ornamental shape represents one or more facial features of the head of the animal.
